(19) United States
(12) Patent Application Publication
(10) Pub. No.: US 2026/0133287 A1
(43) Pub. Date: May 14, 2026

(54) LiDAR DEVICES HAVING HIGH OPTICAL EFFICIENCY AND METHODS OF MANUFACTURING THE SAME

(71) Applicant: SAMSUNG ELECTRONICS CO, LTD., Suwon-si (KR)

(72) Inventors: Jinwoo CHOI, Suwon-si (KR); Sangyun PARK, Suwon-si (KR); Jangwoo YOU, Suwon-si (KR); Byunghoon KO, Suwon-si (KR)

(73) Assignee: SAMSUNG ELECTRONICS CO, LTD., Suwon-si (KR)

(21) Appl. No.: 19/197,572

(22) Filed: May 2, 2025

(30) Foreign Application Priority Data
Nov. 12, 2024 (KR) 10-2024-0160488

(51) Int. Cl. G01S 7/481

(52) U.S. Cl. CPC G01S 7/4811; G01S 7/4815; G01S 7/4816

(57) ABSTRACT

Provided is a light detection and ranging (LiDAR) device including a photonics chip including an optical emitter configured to emit modulated light toward an object, an optical receiver on the photonics chip and configured to receive light reflected from the object through the photonics chip, and a light mixing layer between the photonics chip and the optical receiver, the light mixing layer being configured to mix light incident through the photonics chip with local oscillator light.

### CROSS-REFERENCE TO RELATED APPLICATION

This application claims priority to Korean Patent Application No. 10-2024-0160488, filed on Nov. 12, 2024, in the Korean Intellectual Property Office, the disclosure of which is incorporated by reference herein in its entirety.

### BACKGROUND

### 1. Field

Embodiments of the present disclosure relate to a device for acquiring information about a stationary or mobile object, and more particularly, to a light detection and ranging (LiDAR) device which may increase optical efficiency and a method of manufacturing the LiDAR device.

### 2. Description of Related Art

Optical efficiency has become an important issue for realizing a silicon photonics-based light detection and ranging (LiDAR). Optical power from a transmitter may be determined based on the optical efficiency of a photonics chip. When the intensity of light output from a transmitter is reduced, the distance which may be detected may be reduced. A high-powered laser beam may be used as a light source, but it may be expensive and difficult to handle. Thus, to realize an effective silicon photonics-based LiDAR, the improvement of optical efficiency of photonics chips has become an important research subject.

### SUMMARY

One or more embodiments provide a silicon photonics chip-based light detection and ranging (LiDAR) device which may increase optical efficiency.

One or more embodiments also provide a silicon photonics chip-based LiDAR device which may increase resolution by increasing a pixel density.

One or more embodiments also provide a method of manufacturing a LiDAR device.

One or more embodiments also provide a LiDAR device.

Additional aspects will be set forth in part in the description which follows and, in part, will be apparent from the description, or may be learned by practice of the presented embodiments of the disclosure.

According to an aspect of one or more embodiments, there is provided a light detection and ranging (LiDAR) device including a photonics chip including an optical emitter configured to emit modulated light toward an object, an optical receiver on the photonics chip and configured to receive light reflected from the object through the photonics chip, and a light mixing layer between the photonics chip and the optical receiver, the light mixing layer being configured to mix light incident through the photonics chip with local oscillator light.

The light mixing layer may include a beam splitter.

The LiDAR device may further include a mirror layer on a second side surface of the beam splitter opposite to a first side surface of the beam splitter, the first side surface being configured to receive the low oscillator light.

The LiDAR device may further include a reflective mirror on a second side surface of the beam splitter opposite to a first side surface of the beam splitter, the first side surface being configured to receive low oscillator light.

The light mixing layer may include a waveguide.

The light mixing layer may include a first material layer transparent to infrared rays, and a plurality of second material layer patterns configured to diffuse the low oscillator light incident to the first material layer.

The optical emitter may include a plurality of pixels configured to emit light toward the object, and each of the plurality of pixels may include a light-emitting element configured to emit the light.

The light-emitting element may include a grating coupler.

The optical emitter may include a plurality of pixels configured to emit light toward the object, and each of the plurality of pixels may include two light-emitting elements configured to emit the light and receive the light reflected from the object.

The two light-emitting elements may include grating couplers.

The optical emitter may include a plurality of pixels configured to emit light toward the object, and the optical receiver may include an optical reception device on all of the plurality of pixels.

The optical emitter may include a plurality of pixels configured to emit light toward the object, and the optical receiver may include a plurality of optical reception devices forming one-to-one correspondence with the plurality of pixels.

The optical emitter may include a plurality of pixels configured to emit light toward the object, and the light mixing layer may include a plurality of optical mixing elements forming one-to-one correspondence with the plurality of pixels.

Each optical mixing element of the plurality of optical mixing elements may include an optical splitter.

The LiDAR device may further include a mirror layer on a side surface of the optical splitter.

The LiDAR device may further include a reflective mirror on a side surface of the optical splitter.

The optical receiver may include a plurality of optical reception devices forming one-to-one correspondence with the plurality of pixels.

According to another aspect of one or more embodiments, there is provided a method of manufacturing a light detection and ranging (LiDAR) device, the method including forming a photonics chip including an optical emitter configured to emit modulated light toward an object, forming an optical receiver configured to receive light through the photonics chip, forming a light mixing layer configured to mix light incident through the photonics chip with local oscillator light, and attaching one of the photonics chip and the optical receiver on a first side of the light mixing layer and attaching the other of the photonics chip and the optical receiver onto a second side of the light mixing layer.

The light mixing layer may include an optical splitter.

According to another aspect of one or more embodiments, there is provided a device including a surface, a light detection and ranging (LiDAR) device on the surface, wherein the LiDAR device includes a photonics chip including an optical emitter configured to emit modulated light toward an object, an optical receiver on the photonics chip and configured to receive light reflected from the object through the photonics chip, and a light mixing layer between the photonics chip and the optical receiver, the light mixing layer being configured to mix light incident through the photonics chip with local oscillator light.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of a unit pixel of a first light detection and ranging (LiDAR) device according to one or more embodiments;

FIG. 2 shows light incident into a beam splitter of FIG. 1 from different directions;

FIGS. 3A and 3B are right-side views of the unit pixel of the first LiDAR device of FIG. 1;

FIG. 4 is a cross-sectional view showing an example where a light mixing layer includes a plurality of light mixing elements, and a silicon photonics chip includes a plurality of pixels (optical elements) for emitting light onto an object, in the first LiDAR device of FIG. 1;

FIG. 5 is a cross-sectional view of a second LiDAR device according to one or more embodiments;

FIG. 6 is a more detailed cross-sectional view of a configuration of the first LiDAR of FIG. 1;

FIG. 7 is a more detailed cross-sectional view of a configuration of the LiDAR illustrated in FIG. 4;

FIG. 8 is a cross-sectional view of a third LiDAR device corresponding to one or more other embodiments of the first LiDAR device illustrated in FIG. 6;

FIG. 9 is a cross-sectional view of a fourth LiDAR device corresponding to one or more other embodiments of the first LiDAR device illustrated in FIG. 6;

FIG. 10 is a cross-sectional view of a first example corresponding to a more detailed configuration of the second LiDAR device illustrated in FIG. 5;

FIG. 11 is a cross-sectional view of a second example corresponding to a more detailed configuration of the second LiDAR device illustrated in FIG. 5;

FIG. 12 is a flowchart of a process order for describing a method of manufacturing a LiDAR device, according to one or more embodiments; and

FIG. 13 is a schematic diagram of an electronic device including a LiDAR, according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, a light detection and ranging (LiDAR) device having relatively high optical efficiency and a method of manufacturing the LiDAR device, according to one or more embodiments, are described in detail with reference to the accompanying drawings. In this process, the thickness of a layer or areas illustrated in the drawings may be more or less exaggerated for clarity in the specification.

Embodiments described hereinafter are only examples, and various modifications may be made based on the embodiments. Also, in a layered structure described hereinafter, the expression “above” or “on” may indicate not only a case in which an element is directly above, but also a case in which the element is indirectly above. In the descriptions below, the same reference numerals in each drawing indicate the same members.

A singular expression may include a plural expression, unless an apparently different meaning is indicated in the context. Also, when a part “includes” a certain element, unless it is specifically mentioned otherwise, the part may further include another component and may not exclude the other component.

The term “the” and other equivalent determiners may correspond to a singular referent or a plural referent. Operations included in a method may be performed in an appropriate order, unless the operations included in the method are described to be performed in an apparent order, or unless the operations included in the method are described to be performed otherwise. The operations are not necessarily limited to the described order.

Also, the terms such as “. . . unit,” “module,” or the like used in the specification indicate a unit, which processes at least one function or motion, and the unit may be implemented by hardware or software, or by a combination of hardware and software.

The connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The use of all examples and example terms are merely for describing the disclosure in detail and the disclosure is not limited to the examples and the example terms, unless they are not defined in the scope of the claims.

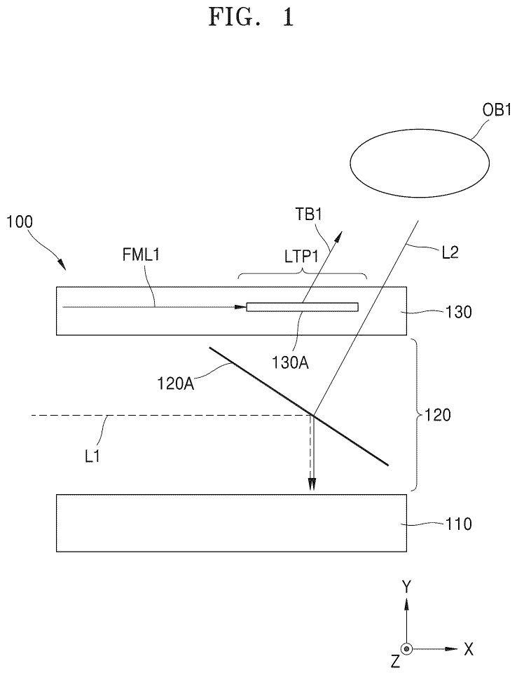

FIG. 1 illustrates a unit pixel of a first LiDAR device 100 according to one or more embodiments.

Referring to FIG. 1, the first LiDAR device 100 according to one or more embodiments may include an optical receiver 110, a light mixing layer 120, and a silicon photonics chip 130, which are sequentially provided. The silicon photonics chip 130 may include an optical emitter LTP1 configured to emit light TB1 toward an object OB1 in order to obtain information about the object OB1. The optical emitter LTP1 may be an optical transmitter. The optical emitter LTP1 may include a grating coupler 130A. Light FML1, the frequency of which is modulated by an optical modulator in the silicon photonics chip 130, may be supplied to the grating coupler 130A. The modulated light FML1 may include continuous waves, but is not limited thereto. The modulated light FML1 supplied to the grating coupler 130A may be emitted toward the object OB1 through diffraction. The light TB1 emitted from the grating coupler 130A toward the object OB1 may be reflected from the object OB1. For example, the object OB1 may include a stationary object or a mobile object, an artificial object, such as an automobile, an airplane, a motorcycle, a streetlight, a building, etc., a natural object, such as an animal, a tree, a rock, etc., or a human being. The light TB1 emitted onto the object OB1 may be reflected or scattered in various directions according to the shape of the object OB1. Thus, light L2 reflected from the object OB1 and received by the first LiDAR device 100 may be received in various directions. The light TB1 emitted onto the object OB1 may be infrared light or may include infrared light. For example, the infrared light may include light having the wavelength of 1550 nm or 1310 nm, but may include light having other wavelengths of the infrared band. The material of the optical emitter LTP1 of the silicon photonics chip 130 may include a material having a relatively lower infrared absorption rate than other materials, such as, for example, silicon or silicon oxide. The light (infrared light) L2 reflected from the object OB1 and incident onto the silicon photonics chip 130 may be incident onto the light mixing layer 120 through the silicon photonics chip 130. The light L2 reflected from the object OB1 may be incident to the light mixing layer 120 through the silicon photonics chip 130 at different angles of incidence. For example the light L2 reflected from the object OB1 may be incident to the light mixing layer 120 in various directions.

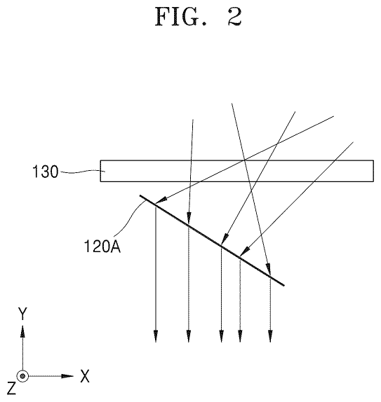

In FIG. 1, for convenience of illustration, light L2 is shown as one ray incident, through the silicon photonics chip 130, to a beam splitter 120A of the light mixing layer 120. However, as described above, the light L2 reflected from the object OB1 may be incident to the silicon photonics chip 130 in various directions. Accordingly, as illustrated in FIG. 2, the light L2 may be incident to the beam splitter 120A of the light mixing layer 120 in various directions (at various angles of incidence). FIGS. 1 and 2 illustrate the beam splitter 120A as an example. However, as described below, the beam splitter 120A may include an optical element having a substantial volume.

The light mixing layer 120 may be a layer configured to mix local oscillator (LO) light L1 with the light L2 reflected from the object OB1 and then incident through the silicon photonics chip 130. The LO light L1 may be light having a frequency that is the same as a frequency of the light TB1 emitted by the optical emitter LTP1 toward the object OB1. The LO light L1 and the light TB1 emitted by the optical emitter LTP1 toward the object OB1 may or may not be emitted from the same light source. For example, the LO light L1 and the light TB1 emitted toward the object OB1 may be emitted from a light source provided in the silicon photonics chip 130, but may be emitted from a light source provided outside the silicon photonics chip 130. For example, the LO light L1 may be emitted from a first light source, and the light TB1 emitted toward the object OB1 may be emitted from a second light source. The first light source and the second light source may be provided to be spaced apart from each other, but to be synchronized to each other for operations. The light mixing layer 120 may include the beam splitter 120A that is configured to mix the LO light L1 with the light L2. In the beam splitter 120A, an interface at which the incident light, that is, the LO light L1 and the light L2, are split may be inclined with respect to the optical emitter LTP1. The light L2 incident to the beam splitter 120A from the object OB1 by passing through the silicon photonics chip 130 may be incident to the optical receiver 110 by passing through the beam splitter 120A. The LO light L1 may be incident to the beam splitter 120A as parallel light or non-parallel light. The LO light L1 may be reflected toward a lower side of the beam splitter 120A and incident to the optical receiver 110. The LO light L1 and the light L2 reflected from the object OB1 and incident may meet at an identical point of the beam splitter 120A and may be incident to the optical receiver 110 together. Thus, light including the LO light L1 and the light L2 that are in an overlapped state, that is, an optical signal in an overlapping state, may be incident to the optical receiver 110. According to a relative movement state of the object OB1 and the silicon photonics chip 130, there may be a time difference or a phase difference between the LO light L1 and the light L2 reflected from the object OB1 and incident on the optical receiver 110. The optical signal in the overlapping state that is incident from the light mixing layer 120 to the optical receiver 110 may be converted into a photoelectric signal by the optical receiver 110. For example, the optical receiver 110 may generate an electrical signal corresponding to the optical signal in the overlapping state. The optical receiver 110 may analyze the generated electrical signal to extract a beat frequency, and, through the analysis of the beat frequency, may measure the distance from the silicon photonics chip 130 to the object OB1 and the speed or the relative speed of the object OB1.

The optical receiver 110 may include at least one optical reception device configured to receive the optical signal in the overlapping state and convert the optical signal in the overlapping state into the photoelectric signal. For example, when one optical emitter LTP1 is referred to as one pixel or one unit pixel in the silicon photonics chip 130, a plurality of pixels may be provided in the silicon photonics chip 130, and the optical receiver 110 may include a number of a plurality of optical reception devices corresponding to a number of the plurality of pixels provided in the silicon photonics chip 130. This aspect will be described below.

For example, the optical reception devices included in the optical receiver 110 may include a balanced photodiode or a single photodiode. The optical receiver 110 may include a circuit portion configured to process and analyze an electrical signal output from the optical reception device. For example, the circuit portion may include a complementary metal oxide semiconductor (CMOS) circuit, but is not limited thereto.

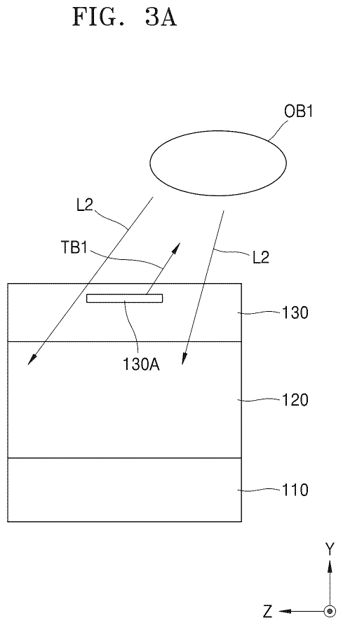

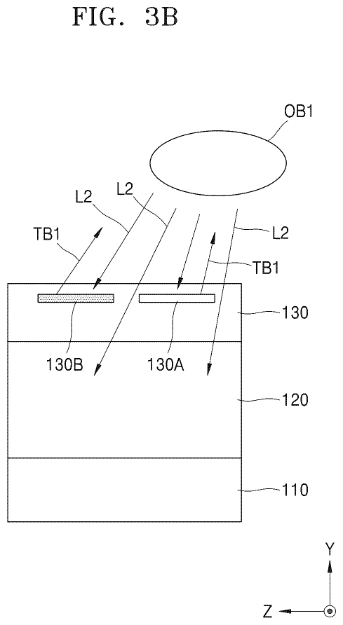

FIGS. 3A and 3B are right-side views of FIG. 1. Referring to FIGS. 1 and 3A and 3B together, as illustrated in FIG. 3A, the optical emitter LTP1 of the unit pixel of the silicon photonics chip 130 may include one grating coupler 130A for optical emission, but as illustrated in FIG. 3B, the optical emitter LTP1 may include two grating couplers 130A and 130B for optical emission. The two grating couplers 130A and 13B may also be used as antennas to receive the light L2 reflected from the object OB1. The light mixing layer 120 may be additionally provided below the silicon photonics chip 130, and thus, the light L2 incident onto or outside of the circumferences of the two couplers 130A and 130B from the object OB1 may not be lost and may be used to extract the beat frequency. Thus, light loss which may occur in the optical mixing and detection process (the bit frequency extraction process) by the first LiDAR device 100 may be minimized.

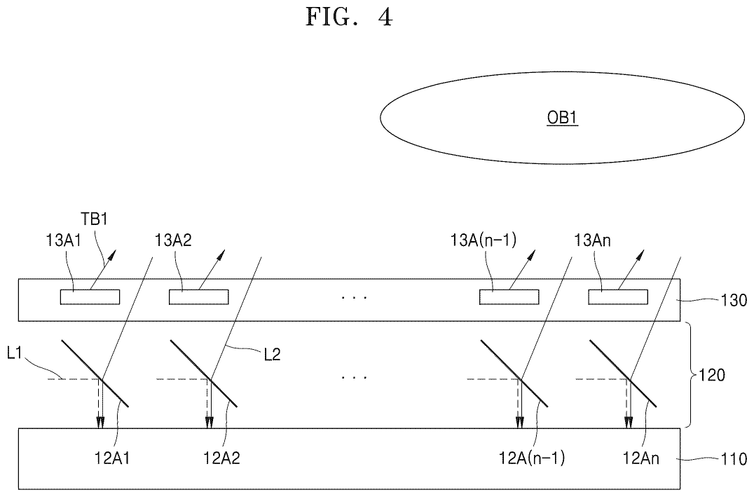

For example, as illustrated in FIG. 4, the silicon photonics chip 130 may include a plurality of pixels that may emit light onto the object OB1, that is, a plurality of optical elements 13A1, 13A2, . . . , 13A(n−1), and 13An (here, n is 1, 2, 3, . . . ). The plurality of optical elements 13A1, 13A2, . . . , 13A(n−1), and 13An may be aligned in a given direction or in a given shape to form an array. For example, the plurality of optical elements 13A1, 13A2, . . . , 13A(n−1), and 13An may form a two-dimensional (2D) array. Each of the optical elements 13A1, 13A2, . . . , 13A(n−1), and 13An may be referred to as an optical device or may correspond to the grating coupler 130A described with reference to FIG. 1. However, each of the optical elements 13A1, 13A2, . . . , 13A(n−1), and 13An may correspond to a different device configured to perform the same operation.

The light mixing layer 120 may include a plurality of beam splitter 12A1, 12A2, . . . , 12A(n−1), and 12An (here, n is 1, 2, 3, . . . ), the number of which is the same as the number of the plurality of optical elements 13A1, 13A2, . . . , 13A(n−1), and 13An. The plurality of beam splitters 12A1, 12A2, . . . , 12A(n−1), and 12An may be arranged to form one-to-one correspondence with the plurality of optical elements 13A1, 13A2, . . . , 13A(n−1), and 13An.

For example, the configuration of each of the beam splitters 12A1, 12A2, . . . , 12A(n−1), and 12An may be the same as the configuration of the beam splitter 120A described with reference to FIG. 1. The optical receiver 110 may include the optical reception device provided to receive the mixed light incident from the plurality of beam splitters 12A1, 12A2, . . . , 12A(n−1), and 12An of the light mixing layer 120. The optical reception device may include one photodiode. For example, one photodiode may be provided to have a relatively large size to correspond to all of the plurality of beam splitters 12A1, 12A2, . . . , 12A(n−1), and 12An, for example, to entirely be provided on and cover the plurality of beam splitters 12A1, 12A2, . . . , 12A(n−1), and 12An.

The LO light L1 supplied to the plurality of beam splitters 12A1, 12A2, . . . , 12A(n−1), and 12An in FIG. 4 may be supplied by providing LO light emission devices, the number of which is the same as the number of the plurality of beam splitters 12A1, 12A2, . . . , 12A(n−1), and 12An. However, after providing one LO light emission device or the LO light emission devices, the number of which is less than the number of the plurality of beam splitters 12A1, 12A2, . . . , 12A(n−1), and 12An, the LO light L1 may be supplied to the plurality of beam splitters 12A1, 12A2, . . . , 12A(n−1), and 12An by using a light splitter.

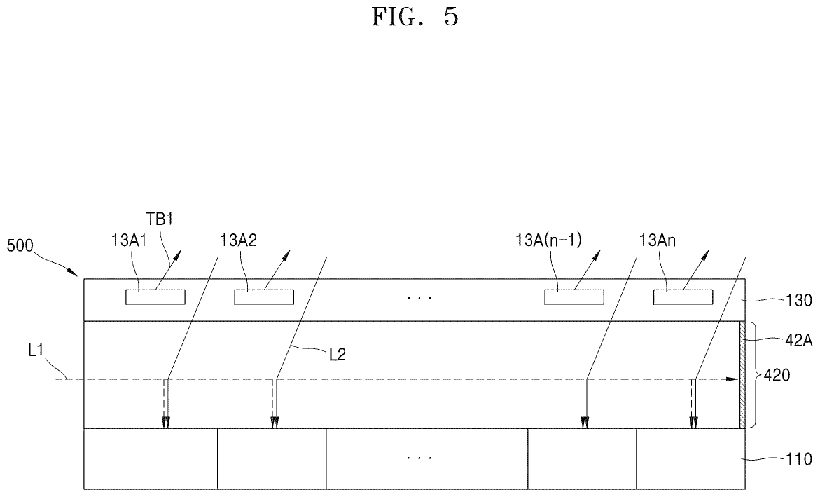

FIG. 5 illustrates a second LiDAR device 500 according to one or more embodiments. Reference numerals the same as the reference numerals in FIGS. 1 to 4 indicate the same members, and their descriptions are omitted.

As illustrated in FIG. 5, the light mixing layer 420 may include other optical devices rather than the beam splitters to mix the light L2 with the LO light L1 in an area corresponding to each pixel. In this case, the optical receiver 110 may be provided to correspond to the plurality of optical elements 13A1, 13A2, . . . , 13A(n−1), and 13An provided in the silicon photonics chip 130. For example, the optical receiver 110 may include the optical reception devices, the number of which is the same as the number of the plurality of optical elements 13A1, 13A2, . . . , 13A(n−1), and 13An. Thus, the optical reception devices included in the optical receiver 110 and the plurality of optical elements 13A1, 13A2, . . . , 13A(n−1), and 13An may form one-to-one correspondence. For example, the optical receiver 110 may include the plurality of optical reception devices (for example, photodiodes) aligned to form one-to-one correspondence with the plurality of pixels of the silicon photonics chip 130. The configuration of the light mixing layer 420 will be described below. A blocking layer 42A to prevent the emission of the LO light L1 toward the right side of the light mixing layer 420 may be provided on a right end of the light mixing layer 420.

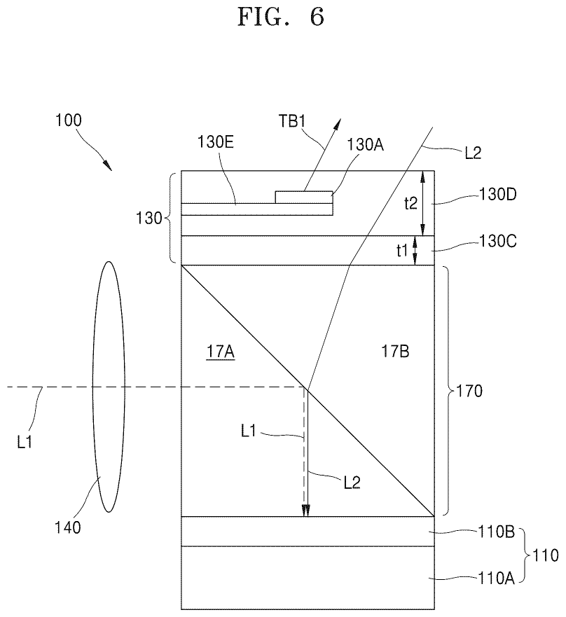

FIG. 6 illustrates the configuration of the first LiDAR device 100 of FIG. 1 in more detail.

Referring to FIG. 6, the optical receiver 110 may include a circuit portion 110A and an optical reception device layer 110B which are sequentially stacked. The circuit portion 110A may control an operation of each optical reception device of the optical reception device layer 110B, may analyze an electrical signal (a photoelectric conversion signal) given from the optical reception device layer 110B to extract a beat frequency, and, based on the extracted beat frequency, may measure the distance from the first LiDAR device 100 to the object OB1 or the speed or the relative speed of the object OB1. The circuit portion 110A may include a program for performing these operations. For example, the extraction of the beat frequency or the measurement of the distance to the object OB1 or the speed of the object OB1 may be performed by a calculator connected to the first LiDAR device 100. The silicon photonics chip 130 may include a silicon layer 130C and an insulating layer 130D which are sequentially stacked. The silicon layer 130C may be directly or indirectly in contact with a light mixing layer 170. The silicon layer 130C may be referred to as a substrate, a base layer, etc. For example, the silicon layer 130C may have a first thickness t1 to minimize the absorption of the light L2. For example, the first thickness t1 of the silicon layer 130C may be about 200 nm to about 500 nm. The silicon layer 130C may be referred to as a substrate, a base substrate, a base layer, etc. For example, the silicon layer 130C may be substituted with another material layer which may perform the same function as the silicon layer 130C. The insulating layer 130D may have a second thickness t2 to minimize the absorption of the light L2. For example, the second thickness t2 may be about 1 μm to about 5 μm, but is not limited thereto. For example, the insulating layer 130D may include a silicon oxide (for example, SiO₂) layer, but is not limited thereto. The insulating layer 130D may include a waveguide 130E and the grating coupler 130A provided on and connected to the waveguide 130E. The waveguide 130E may be provided to connect an optical modulator with the grating coupler 130A. For example, the grating coupler 130A may be a grating formed at an end of the waveguide 130E and may be integrally formed with the waveguide 130E. For example, the waveguide 130E and the grating coupler 130A may include materials having low infrared absorption rates, for example, silicon (Si). The waveguide 130E and the grating coupler 130A may be embedded in the insulating layer 130D. The thickness of the insulating layer 130D above the grating coupler 130A may be smaller than the thickness of the insulating layer 130D below the grating coupler 130A.

The light mixing layer 170 may be provided on the optical reception device layer 110B of the optical receiver 110. A bottom surface of the light mixing layer 170 may be directly or indirectly in contact with the optical reception device layer 110B, and a top surface of the light mixing layer 170 may be directly or indirectly in contact with a bottom surface of the silicon layer 130C. The light mixing layer 170 may correspond to the light mixing layer 120 of FIG. 1. The light mixing layer 170 may be or may include a beam splitter including two prisms 17A and 17B. Slope surfaces of the two prisms 17A and 17B may face each other and may be in contact with each other.

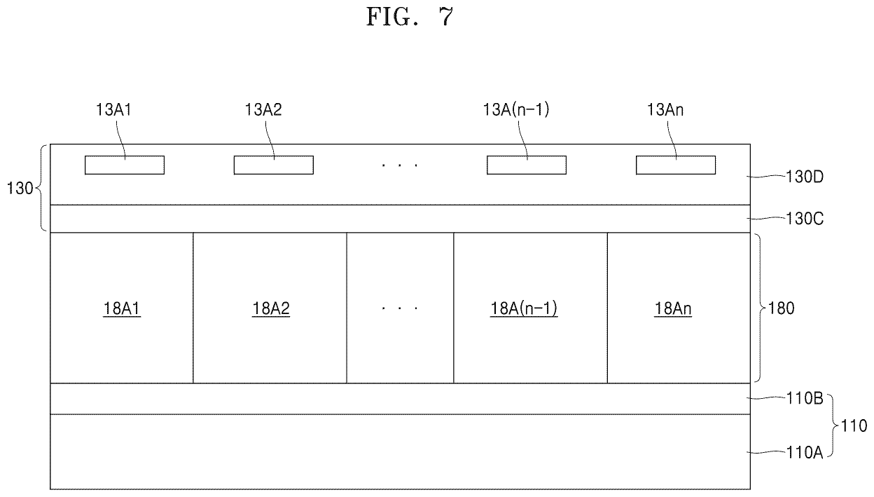

FIG. 7 shows, in more detail, the configuration of the LiDAR device illustrated in FIG. 4. Reference numerals in FIG. 7 that are the same as the reference numerals in FIGS. 4 and 6 indicate the same members, and their descriptions are omitted.

Referring to FIG. 7, a light mixing layer 180 provided between the optical receiver 110 and the silicon photonics chip 130 may include a plurality of optical mixing elements (for example, a plurality of optical mixing optical devices) 18A1, 18A2, . . . , 18A(n−1), and 18An (here, n is 1, 2, 3, . . . ). A number of the plurality of optical mixing elements 18A1, 18A2, . . . , 18A(n−1), and 18An may be a same as the number of the pixels of the silicon photonics chip 130, that is, the number of the plurality of optical elements 13A1, 13A2, . . . , 13A(n−1), and 13An provided in the silicon photonics chip 130. Thus, the plurality of optical mixing elements 18A1, 18A2, . . . , 18A(n−1), and 18An of the light mixing layer 180 may form one-to-one correspondence with the pixels of the silicon photonics chip 130. The configuration of each of the optical mixing elements 18A1, 18A2, . . . , 18A(n−1), and 18An may be the same as or different from the configuration of the light mixing layer 170 of FIG. 6. For example, the optical reception device layer 110B of the optical receiver 100 may include one photodiode which may cover all of the plurality of optical mixing elements 18A1, 18A2, . . . , 18A(n−1), and 18An, but may include a plurality of photodiodes, the number of which is the same as the number of the plurality of optical mixing elements 18A1, 18A2, . . . , 18A(n−1), and 18An, to form one-to-one correspondence with the plurality of optical mixing elements 18A1, 18A2, . . . , 18A(n−1), and 18An.

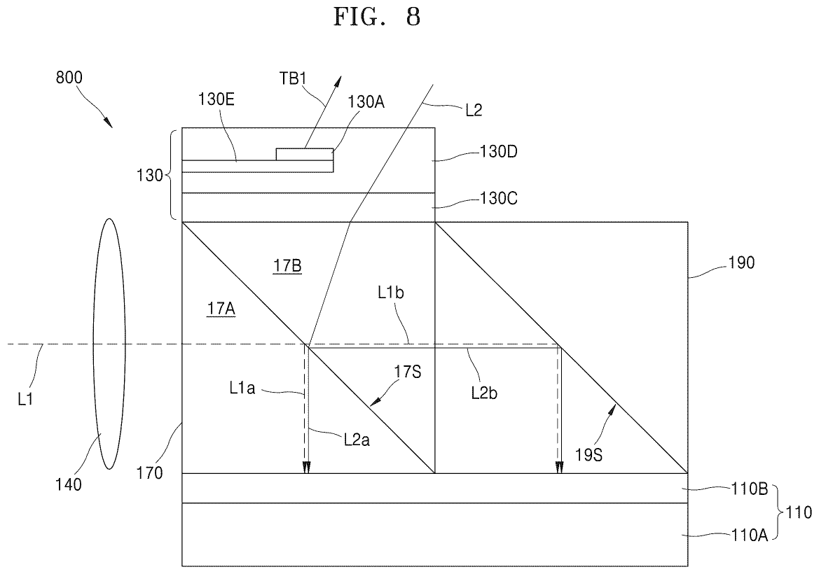

FIG. 8 shows one or more other embodiments of the first LiDAR device 100 illustrated in FIG. 6. FIG. 8 may correspond to a third LiDAR device 800 according to one or more embodiments. Only different aspects from the first LiDAR device 100 illustrated in FIG. 6 are described.

Referring to FIG. 8, the light mixing layer 170 and a mirror layer 190 may be provided on the optical reception device layer 110B of the optical receiver 110. The light mixing layer 170 and the mirror layer 190 may be horizontally aligned such that optical axes thereof correspond to each other. The mirror layer 190 may be arranged on the right side of the light mixing layer 170. The mirror layer 190 may be provided to be directly in contact with the light mixing layer 170. For example, a right side surface of the light mixing layer 170 may be directly in contact or indirectly (for example, through another transparent member) in contact with a left side surface of the mirror layer 190. The height of the mirror layer 190 may be the same or substantially the same as the height of the light mixing layer 170. The mirror layer 190 may include a glass layer including an optical reflection surface 19S parallel with a contact surface of the two prisms 17A and 17B of the light mixing layer 170 or may include a glass layer on which the optical reflection surface 19S is formed, but is not limited thereto.

The LO light L1 incident to the light mixing layer 170 through a lens 140 may be reflected from a surface 17S of the light mixing layer 170, on which light splitting occurs, to be incident to the optical receiver 110. A reference number L1a indicates the LO light L1 that is reflected by the surface 17 and then is incident to the optical receiver 110. The light L2 reflected from the object OB1 and incident to the light mixing layer 170 may pass through the surface 17S to be incident to the optical receiver 110. A reference number L2a indicates the light L2 that transmits the surface 17S and then is incident to the optical receiver 110. However, in this process, a portion L1b of the LO light L1 may pass through the optical splitting surface 17S of the light mixing layer 170 and may be emitted through the right side surface of the light mixing layer 170, and another portion L2b of the light L2 reflected from the object OB1 and incident may be reflected from the optical splitting surface 17S and may be emitted through the right side surface of the light mixing layer 170. The portion L1b of the LO light L1 and the other portion L2b of the light L2 may be relatively very small amounts. The light L1b and L2b emitted as described above may be loss light, and may be a factor to deteriorate optical efficiency of the LiDAR device. The mirror layer 190 may be provided on the right side of the light mixing layer 170, and thus, the light L1b and L2b emitted through the right side surface of the light mixing layer 170 may be reflected from the optical reflection surface 19S of the mirror layer 190 and then incident to the optical receiver 110. By taking into account this operation of the mirror layer 190, the mirror layer 190 may be referred to as an optical efficiency improvement layer of the LiDAR device, an auxiliary layer for improving optical efficiency of the LiDAR device, etc. The light mixing layer 170 and the mirror layer 190 may be commonly referred to as the light mixing layer.

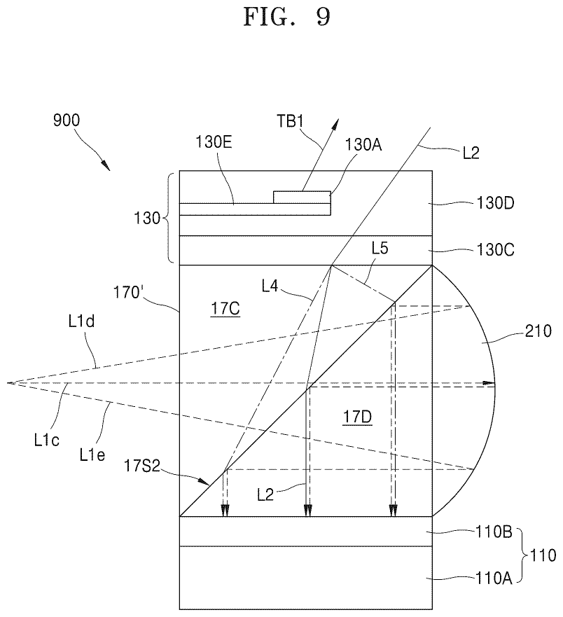

FIG. 9 shows one or more embodiments of the first LiDAR device 100 illustrated in FIG. 6. FIG. 9 may correspond to a fourth LiDAR 900 according to one or more embodiments. Only different aspects from the first LiDAR device 100 illustrated in FIG. 6 are described.

Referring to FIG. 9, a reflective mirror 210 may be provided on the right side of a light mixing layer 170′. The light mixing layer 170′ may include two prisms 17C and 17D, and the two prisms 17C and 17D may be attached to each other such that a bonding surface, that is, an optical splitting surface 17S2 is inclined toward the right side. The light mixing layer 170′ may be the light mixing layer 170 of FIG. 8, which is rotated by 90 degrees toward the right side. For example, the reflective mirror 210 may include a spherical reflective mirror convex toward the outside. The reflective mirror 210 may be provided to entirely cover the right side surface of the light mixing layer 170′. As described with reference to FIG. 8, a portion of each of LO light L1c, L1d, and L1e incident to the light mixing layer 170′ may pass through the splitting surface 17S2 of the light mixing layer 170′ and then be emitted through the right side surface of the light mixing layer 170′, although the portion is a relatively small amount. As illustrated in FIG. 9, the light emitted as described above may be sequentially reflected by the reflective mirror 210 and the splitting surface 17S2, and then, may be incident to the optical receiver 110 together with the light L2 incident from the object OB1.

The reference numerals L4 and L5 in FIG. 9 indicate light incident to the light mixing layer 170′ in a direction different from a direction of the light indicated by the reference numeral L2, among the light reflected from the object OB1 and incident to the light mixing layer 170′. The light mixing layer 170′ and the reflective mirror 210 may be commonly referred to as the light mixing layer. The light mixing layer 170′ and the reflective mirror 210 may be on the same optical axis.

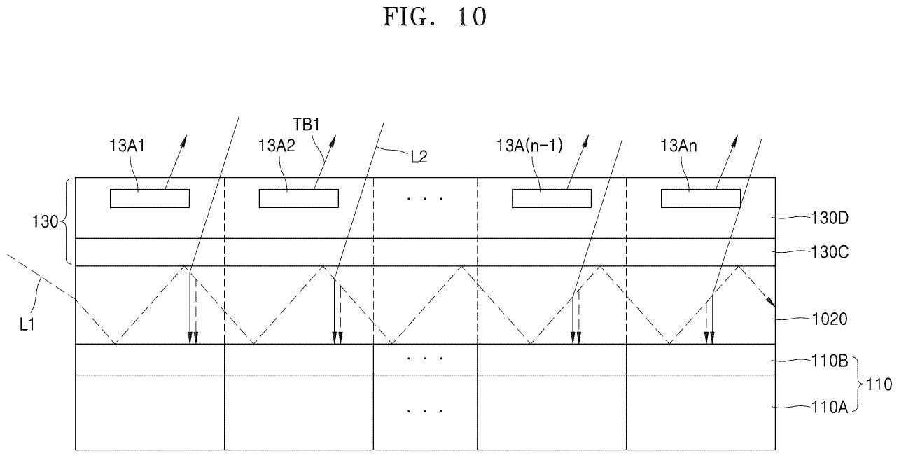

FIG. 10 shows a first example of a more detailed configuration of the second LiDAR device 500 illustrated in FIG. 5. Reference numerals in FIG. 10 that are the same as the reference numerals in FIGS. 5 and 7 indicate the same members, and their descriptions are omitted.

Referring to FIG. 10, a light mixing layer 1020 provided between the optical receiver 110 and the silicon photonics chip 130 may include a waveguide. For example, the entire light mixing layer 1020 may correspond to one waveguide, and the waveguide may be provided to correspond to all of the plurality of optical elements 13A1, 13A2, . . . , 13A(n−1), and 13An of the silicon photonics chip 130. The LO light L1 applied to the light mixing layer 1020 through one side surface of the light mixing layer 1020 may be propagated in the light mixing layer 1020 through total reflection. Thus, when the LO light L1 is applied to the light mixing layer 1020, the LO light L1 may be applied at an angle of incidence which may satisfy the condition for total reflection in the light mixing layer 1020. When the LO light L1 progressing in the light mixing layer 1020 through total reflection and the light L2 reflected from the object OB1 and incident to the light mixing layer 1020 have corresponding phases or are coherent light at a certain point, the LO light L1 and the light L2 reflected from the object OB1 and incident may be incident to the optical receiver 110 together at the corresponding point.

Areas of the optical reception device layer 110B and the circuit portion 110A of the optical receiver 110 may be divided into the number of areas corresponding to the number of pixels of the silicon photonics chip 130. For example, the optical reception device layer 110B may include the optical reception devices, the number of which is the same as the number of pixels of the silicon photonics chip 130, and the optical reception devices may be aligned to form one-to-one correspondence with the pixels of the silicon photonics chip 130 by taking into account the alignment shape of the pixels. The circuit portion 110A may include control devices (for example, transistors, etc.) forming one-to-one correspondence with the optical reception devices, in order to control an operation of each of the optical reception devices.

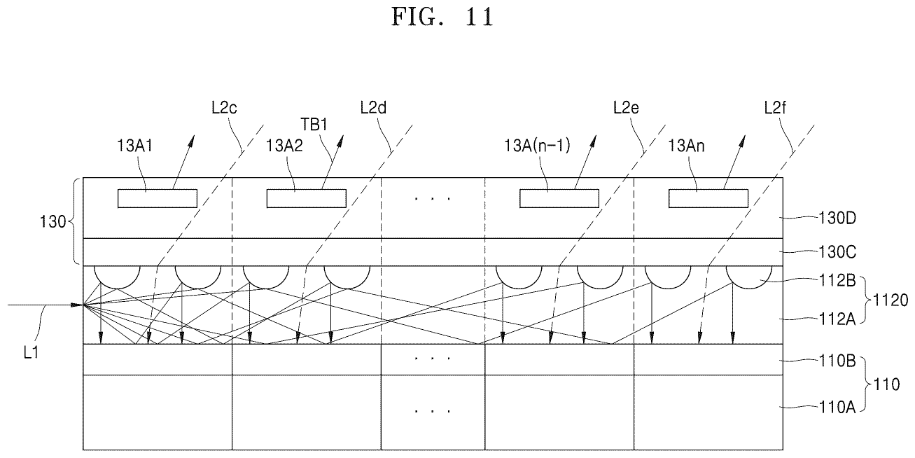

FIG. 11 shows a second example corresponding to a more detailed configuration of the second LiDAR device 500 illustrated in FIG. 5. Only different aspects from FIG. 10 are described.

Referring to FIG. 11, a light mixing layer 1120 provided between the optical receiver 110 and the silicon photonics chip 130 may include a first material layer 112A transparent to infrared rays and a plurality of second material layer patterns 112B provided to diffuse the LO light L1 applied to the first material layer 112A. The first material layer 112A may be provided on the optical reception device layer 110B of the optical receiver 110 and may entirely be provided on and cover the optical reception device layer 110B. The plurality of second material layer patterns 112B may be provided to be embedded in a top portion of the first material layer 112A and may be arranged to be spaced apart from each other. The second material layer patterns 112B, except for top surfaces of the second material layer patterns 112B, may be embedded in the first material layer 112A. All of the top surfaces of the second material layer patterns 112B and a top surface of the first material layer 112A between the second material layer patterns 112B may be covered by the silicon layer 130C of the silicon photonics chip 130 and may be directly or indirectly in contact with a bottom surface of the silicon layer 130C. For example, the plurality of second material layer patterns 112B may be a hemispherical material layer including the top surfaces and hemispherical surfaces, and the top surfaces may be directly or indirectly in contact with the bottom surface of the silicon layer 130C of the silicon photonics chip 130. As a result, the plurality of second material layer patterns 112B may be protrusions protruding to be downwardly convex toward the first material layer 112A from the bottom surface of the silicon layer 130C. The bottom surface of the silicon layer 130C between the protrusions 112B may be covered by the top surface of the first material layer 112A. The diameter of the second material layer pattern 112B may have a value in the range in which the LO light L1 may be scattered as much as possible in consideration of the wavelength of the LO light L1. The second material layer patterns 112B may be provided on the top portion of the first material layer 112A, and thus, the LO light L1 incident to the first material layer 112A may be scattered by the second material layer patterns 112B, and when a condition is met, the LO light L1 may be totally reflected at an interface between the first material layer 112A and the optical receiver 110. Accordingly, the LO light L1 incident to the first material layer 112A may be propagated in the whole first material layer 112A. At least a portion of the LO light L1 propagated in the first material layer 112A may be incident to the optical receiver 110 together with light L2c, L2d, L2e, and L2f reflected from the object OB1 and incident to the light mixing layer 1120 in different directions.

For example, the first material layer 112A may include a material having an infrared absorption rate lower than infrared absorption rate of other materials and transparent to infrared rays, and the second material layer patterns 112B may include a material having an infrared absorption rate lower than infrared absorption rate of other materials and non-transparent to infrared rays. The second material layer patterns 112B and the optical receiver 110 may be spaced apart from each other. The second material layer patterns 112B may also be referred to as an optical diffusion layer. For example, one or more second material layer patterns 112B may correspond to one pixel of the silicon photonics chip 130.

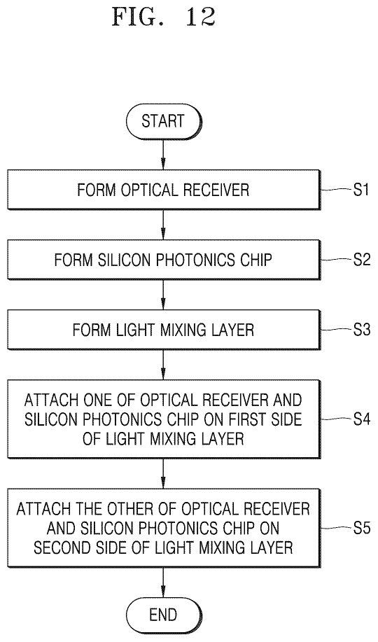

FIG. 12 is a flowchart of a process order of a method of manufacturing a LiDAR device, according to one or more embodiments.

Referring to FIG. 12, an optical receiver may be formed to manufacture the LiDAR device (S1), according to one or more embodiments. Also, additionally, a silicon photonics chip may be formed (S2). Also, additionally, a light mixing layer may be formed (S3). After forming the optical receiver, the silicon photonics chip, and the light mixing layer, one of the optical receiver and the silicon photonics chip may be attached onto a first side of the light mixing layer (S4), and then, the other may be attached onto a second side of the light mixing layer (S5). The second side may be the opposite side to the first side. For example, the first side may include a top surface of the light mixing layer, and the silicon photonics chip may be directly or indirectly attached onto the top surface of the light mixing layer. For example, the second side may be a bottom surface of the light mixing layer, and the optical receiver may be directly or indirectly attached onto the bottom surface of the light mixing layer. The attachment may be performed by a bonding method and an adhesive may be used for the attachment. When the silicon photonics chip and the optical receiver are bonded to the light mixing layer by using only the adhesive, the silicon photonics chip and the optical receiver may be directly attached onto the light mixing layer.

For example, in the process of forming the silicon photonics chip, a unit pixel of an optical emitter configured to emit light to the outside by using frequency-modulated continuous wave (FMCW) light that is incident to the optical emitter may provide only one optical element (for example, a grating coupler) for optical emission or may provide two optical elements (for example, grating couplers) for both optical emission and optical reception.

In the process of forming the light mixing layer, the light mixing layer (for example, the light mixing layers illustrated in FIGS. 6 to 11) having various layer configurations and layer structures described above may be formed.

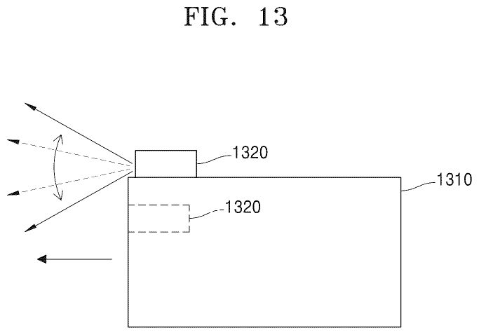

FIG. 13 shows a device 1310 including a LiDAR device 1320, according to one or more embodiments. For example, the device 1310 may include an electronic device, but is not limited thereto.

Referring to FIG. 13, the device 1310 may include the LiDAR device 1320. The LiDAR device 1320 may be attached outside the device 1310 or may be provided in the device 1310 as illustrated by dotted lines. A horizontal arrow in FIG. 13 indicates a proceeding direction of the device 1310, when the device 1310 is a mobile device. For example, the LiDAR device 1320 may be attached to be rotatable. Thus, a user of the device 1310 may observe the field of vision of 360 degrees through the LiDAR device 1320.

For example, the device 1310 may include a vehicle (for example, a manned or unmanned vehicle, an autonomous vehicle, etc.) For example, the device 1310 may include an aerial vehicle flying in the air (for example, a manned or unmanned airplane, a manned or unmanned drone, etc.). For example, the device 1310 may include a passive or an active robot. The active robot may include an autonomous robot. For example, the device 1310 may include a boat, a ship or a submarine operating at sea or on the seabed.

The LiDAR device described above may be based on the silicon photonics chip, but may perform optical mixing and optical reception outside the silicon photonics chip. Thus, most of the light reflected from an object and received by the silicon photonics chip may be received and mixed with LO light to extract the beat frequency. Thus, light loss in the process of optical mixing and extraction may be minimized, and thus, optical efficiency of the LiDAR device may be increased.

Also, only an antenna (the grating coupler) for light emission may be provided in the pixel of the optical emitter of the silicon photonics chip, and thus, the area of the pixel may be reduced, which may lead to an increase in pixel density of the silicon photonics chip. As a result, the resolution with respect to the object may be increased.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by one of ordinary skill in the art that various changes in form and details may be made therein without departing from the spirit and scope as defined by the following claims and their equivalents.

What is claimed is:

1. A light detection and ranging (LiDAR) device comprising:
a photonics chip comprising an optical emitter configured to emit modulated light toward an object;
an optical receiver on the photonics chip and configured to receive light reflected from the object through the photonics chip; and
a light mixing layer between the photonics chip and the optical receiver, the light mixing layer being configured to mix light incident through the photonics chip with local oscillator light.

2. The LiDAR device of claim 1, wherein the light mixing layer comprises a beam splitter.

3. The LiDAR device of claim 2, further comprising a mirror layer on a second side surface of the beam splitter opposite to a first side surface of the beam splitter, the first side surface being configured to receive the local oscillator light.

4. The LiDAR device of claim 2, further comprising a reflective mirror on a second side surface of the beam splitter opposite to a first side surface of the beam splitter, the first side surface being configured to receive local oscillator light.

5. The LiDAR device of claim 1, wherein the light mixing layer comprises a waveguide.

6. The LiDAR device of claim 1, wherein the light mixing layer comprises:
a first material layer transparent to infrared rays; and
a plurality of second material layer patterns configured to diffuse the local oscillator light incident to the first material layer.

7. The LiDAR device of claim 1, wherein the optical emitter comprises a plurality of pixels configured to emit light toward the object, and
wherein each of the plurality of pixels comprises a light-emitting element configured to emit the light.

8. The LiDAR device of claim 7, wherein the light-emitting element comprises a grating coupler.

9. The LiDAR device of claim 1, wherein the optical emitter comprises a plurality of pixels configured to emit light toward the object, and
wherein each of the plurality of pixels comprises two light-emitting elements configured to emit the light and receive the light reflected from the object.

10. The LiDAR device of claim 9, wherein the two light-emitting elements comprise grating couplers.

11. The LiDAR device of claim 1, wherein the optical emitter comprises a plurality of pixels configured to emit light toward the object, and
wherein the optical receiver comprises an optical reception device on all of the plurality of pixels.

12. The LiDAR device of claim 1, wherein the optical emitter comprises a plurality of pixels configured to emit light toward the object, and
wherein the optical receiver comprises a plurality of optical reception devices forming one-to-one correspondence with the plurality of pixels.

13. The LiDAR device of claim 1, wherein the optical emitter comprises a plurality of pixels configured to emit light toward the object, and
wherein the light mixing layer comprises a plurality of optical mixing elements forming one-to-one correspondence with the plurality of pixels.

14. The LiDAR device of claim 13, wherein each optical mixing element of the plurality of optical mixing elements comprises an optical splitter.

15. The LiDAR device of claim 14, further comprising a mirror layer on a side surface of the optical splitter.

16. The LiDAR device of claim 14, further comprising a reflective mirror on a side surface of the optical splitter.

17. The LiDAR device of claim 13, wherein the optical receiver comprises a plurality of optical reception devices forming one-to-one correspondence with the plurality of pixels.

18. A method of manufacturing a light detection and ranging (LiDAR) device, the method comprising:
forming a photonics chip comprising an optical emitter configured to emit modulated light toward an object;
forming an optical receiver configured to receive light through the photonics chip;
forming a light mixing layer configured to mix light incident through the photonics chip with local oscillator light; and
attaching one of the photonics chip and the optical receiver on a first side of the light mixing layer and attaching the other of the photonics chip and the optical receiver onto a second side of the light mixing layer.

19. The method of claim 18, wherein the light mixing layer comprises an optical splitter.

20. A device comprising:
a surface;
a light detection and ranging (LiDAR) device on the surface,
wherein the LiDAR device comprises:
a photonics chip comprising an optical emitter configured to emit modulated light toward an object;
an optical receiver on the photonics chip and configured to receive light reflected from the object through the photonics chip; and
a light mixing layer between the photonics chip and the optical receiver, the light mixing layer being configured to mix light incident through the photonics chip with local oscillator light.
